(19) United States
(12) Patent Application Publication
(10) Pub. No.: US 2017/0363139 A1
(43) Pub. Date: Dec. 21, 2017

(54) Adhesive hook

(71) Applicant: Dongguan Hongyi Chemical Co., Ltd., Dongguan (CN)

(72) Inventor: Guanghe Wang, Dongguan (CN)

(21) Appl. No.: 15/696,766

(22) Filed: Sep. 6, 2017

(30) Foreign Application Priority Data
Oct. 19, 2016 (CN) 201621175581.3
Jun. 14, 2017 (CN) 201710447635.X

(51) Int. Cl. F16B 47/00; F16B 45/00; B29C 65/14; F16M 13/02; B29C 65/48; C09J 175/14; B29L 31/00

(52) U.S. Cl. CPC F16B 47/003; B29C 65/4845; F16B 45/00; C09J 175/14; B29C 65/1406; F16M 13/02; B29K 2995/0026; B29K 2995/0029; B29L 2031/738

(57) ABSTRACT

An adhesive hook includes a base which has a bottom for fixing, an outer surface, and a hook provided at the outer surface. The bottom of the base is fixed on an external surface by means of an adhesive, and the adhesive is a curable adhesive. The structure of the adhesive hook is simple, and the curing speed of the curable adhesive is fast. After the curing process, the load bearing of the hook is larger than 1 Kg/cm2. Further, the adhesive hook has high cohesion strength after the adhesive is cured, and no remain is pasted on the external surface or the base after the hook is removed. The base can be recoated with new adhesive to reuse, which reduces cost and achieves recycling.

### CROSS-REFERENCE TO RELATED APPLICATIONS

This application claims the benefit of priority to Chinese Invention Application No. 201710447635.X, filed Jun. 14, 2017, and Chinese Utility Application No. 201621175581.3, filed Oct. 19, 2016, which is hereby incorporated by reference in its entirety.

### FIELD OF THE INVENTION

The invention relates to a technical field of article fixing, and more particularly to an adhesive hook.

### BACKGROUND OF THE INVENTION

Currently, adhesive hooks are commonly used to hang article, for example, in washing rooms. Such adhesive hooks are pasted on the wall by means of adhesives, therefore the adhesives plays a critical role on judging the quality of the hooks.

Chinese application publication CN105462522A discloses a hook that uses waterborne acrylic acid-butyl acrylate copolymer resin adhesive and curing agent, thus the load bearing is strong, and the adhesiveness is excellent. Specifically, a button is configured on the hook, in which the curing agent is contained. By pressing the button, the curing agent contacts the adhesives to cure it. Obviously, such a curing manner brings a complicated structure to increase manufacturing cost for the hooks.

Chinese application publication CN201700984U discloses an adhesive hook, which includes a rectangular glass sheet and a metal sheet is attached on the back surface of the glass plate via all-purpose adhesive, and an upper hook and a lower hook are formed on the metal sheet respectively. Glass adhesive is coated on the back surface of the glass sheet and then is pasted on an external surface. After that, the glass sheet must be fixed by additional adhesive tape for several days to make the adhesive to cure sufficiently. Such an adhesive hook is steady, but long curing time is required, and the removal of the hook is difficult.

American application publication US2010/0230565A1 discloses a surface adhesion device which includes a threaded body and a member connected with the threaded body for hanging article. The threaded body is fixed on the wall by means of adhesive which is pressure-sensitive adhesive, such as acrylic or rubber-based PSA or foam-lined PSA material. Such an adhesive can achieve a permanent adhesion and a strong load bearing, but the structure is complicated, and manufacturing cost is high. Furthermore, the curing speed is slow, and the removal of the adhesive is difficult, thus it was not widely used.

### SUMMARY OF THE INVENTION

One objective of the present invention is to provide an adhesive hook, the hook has simple structure, fast curing speed, and advantages of quick removal without adhesive remains, and is recyclable to reduce manufacturing cost.

To achieve the above-mentioned objective, the present invention provides an adhesive hook including a base which has a bottom for fixing, an outer surface, and a hook provided at the outer surface. The bottom of the base is fixed on an external surface by means of an adhesive, and the adhesive is a curable adhesive.

Preferably, the external surface is a marble surface, a wood surface, a concrete wall surface, a tile surface or a glass surface.

Preferably, the adhesive is liquid or gel before it's cured, and the adhesive is solid after it's cured.

Preferably, the adhesive comprises below compositions: oligomers 30%-75%, monomers 20%-70%, photoinitiators 1%-6% and additives 1.1%-13.8%.

Preferably, the additives comprise at least one selected from a group of thickener 0.5%-8%, leveling agent 0-0.5%, coupling agent 0.5%-5% and defoamer 0.1%-0.3%.

Preferably, the oligomers comprise at least one selected from a group of SARTOMER CN966J75NS, Doublemer 353H, EBECRYL 8413, the monomers comprise at least one selected from a group of BOA, TMPTA, ACMO, THFA, and the photoinitiators comprise at least one selected from a group of TPO and 184.

Preferably, the thickener is fumed silica, and the coupling agent is silicon coupling agent KH-550 or silicon coupling agent KH-570.

Preferably, a bottom edge of the base is provided with an operation portion which is a notch formed by dipping an intersecting portion between a side of the base and the bottom of the base.

Preferably, the notch is trapezoidal or crescent-shaped, and the notch has an inclined inner top wall.

Preferably, the base is made of translucent or transparent material.

Preferably, the base and the hook are formed in an integrated structure by mean of injection molding, and made by translucent or transparent plastic with a light transmittance over 30%.

Preferably, the base and the hook are formed in individual structures, and the hook is pivotally connected to the base via an engaging structure, the hook is made of metal, a mounting ridge is protruded on the outer surface of the base, and the engaging structure is inserted into the mounting ridge.

Preferably, a ring of flange is formed around the base to form a recess where the adhesive is coated to prevent the adhesive from overbriming the bottom of the base.

Preferably, the base and/or hook are made of plastic or glass, and the plastic is at least one selected from a group of polystyrene, polyethylene, polypropylene, acrylonitrile-butadiene-styrene copolymer, polyethylene terephthalate and polycarbonate.

Accordingly, the present invention provides an assembly method of the adhesive hook which includes:

providing a base, which has a bottom for fixing, an outer surface, and a hook provided at the outer surface;

pasting the bottom of the base on an external surface, with the bottom is coated with an adhesive that is a curable adhesive; and

curing the adhesive by means of ultraviolet light to fix the base on the external surface.

Preferably, power of the UV light is in a range of 1-6W, curing time is 3-20 seconds, and curing energy is 500-1000 mj/cm².

In comparison with the prior arts, since the base of the adhesive hook according to the present invention is coated with a curable adhesive, and then is pasted on an external surface by curing the adhesive. The structure of the adhesive hook is simple, and the curing speed of the curable adhesive is fast. After the curing process, the load bearing of the hook is larger than 1 Kg/cm². Further, the adhesive hook has high cohesion strength after the adhesive is cured, and no remain is pasted on the external surface or the base after the hook is removed. The base can be recoated with new adhesive to reuse, which reduces cost and achieves recycling.

### BRIEF DESCRIPTION OF THE DRAWINGS

The accompanying drawings facilitate an understanding of the various embodiments of this invention. In such drawings:

FIG. 1 is a perspective exploded view of an adhesive hook according to a first embodiment of the present invention;

FIG. 2 is a perspective view of an adhesive hook according to a first embodiment of the present invention;

FIG. 3 is a side view of an adhesive hook according to a first embodiment of the present invention;

FIG. 4 is a bottom view of an adhesive hook according to a first embodiment of the present invention;

FIG. 5 is a perspective view of an adhesive hook according to a second embodiment of the present invention; and

FIG. 6 is a perspective view of an adhesive hook according to a third embodiment of the present invention.

### DETAILED DESCRIPTION OF ILLUSTRATED EMBODIMENTS

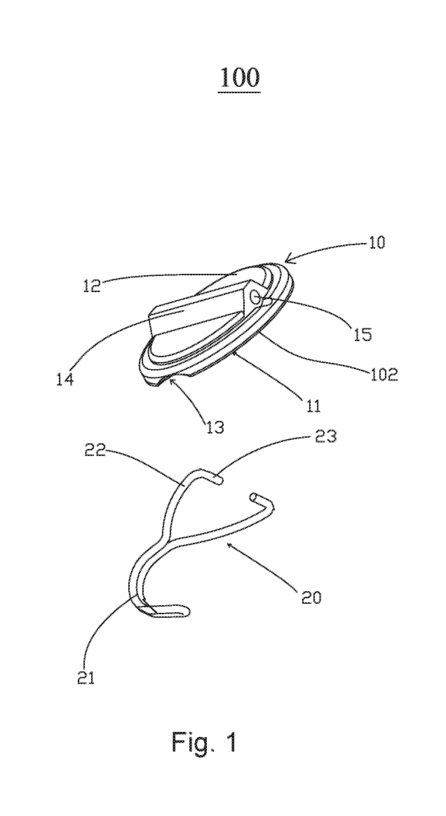

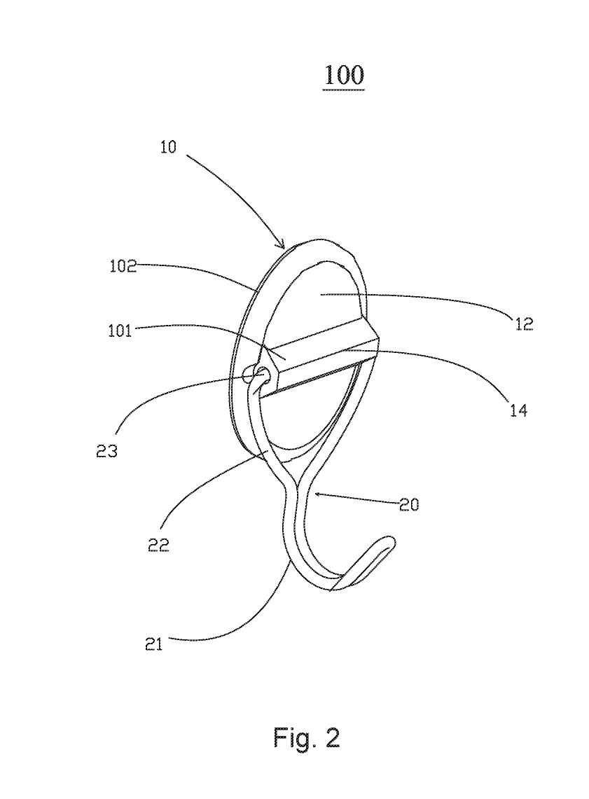

As shown in FIGS. 1 and 2, an adhesive hook 100 according to a first embodiment includes a base 10 having a bottom 11 for fixing and an outer surface 12, a hook 20 is provided at the outer surface 12 of the base 10. The bottom 11 of the base 10 is fixed on an external surface by means of an adhesive. An operating portion 13 is formed on the edge of the bottom 11, which is a notch formed by dipping the intersecting portion between a side of the base 10 and the bottom 11 of the base 10. The external surface is a marble surface, a wood surface, a concrete wall surface, a tile surface or a glass surface. That is, the flatness of the external surface where the adhesive hook 100 is attached is not limited, and the external surface can be smooth or rough.

Further, the base 10 and the hook 20 can be formed in integrated structure or individual structures. In the integrated structure, the base 10 and the hook 20 are formed in the integrated structure by mean of injection molding, and made by translucent plastic or transparent plastic. In the embodiment of the individual structures, the hook 20 is pivotally connected to the base 10 via an engaging structure, and the hook 20 is a metal hook preferably.

Specifically, in the first embodiment, as shown in FIGS. 1 and 2, the base 10 and the hook 20 are formed in individual structures. A mounting ridge 14 is protruded on the outer surface 12 of the base 10, and the engaging structure is engaged with the mounting ridge 14. The engaging structure of the hook includes two clamps 23 which are expanded elastically and keeps an inward force trend. The hook 20 can be removed from the base 10 by pulling the clamps 23. Specifically, the two clamps 23 are inserted into two end holes 15 of the mounting ridge 14 to remount the hook 20 on the base 10. Further, the hook 20 includes a bending section 21 for hanging articles and a connection section 22 connected with the base 10. The connection section 22 includes the clamps 23 at the ends to engage with the holes 15, preferably, the diameter of the clamp 23 is slightly smaller than the diameter of the hole 15, thereby maintaining a possible motion of the hook 20 in the holes 15. In this embodiment, the hook 20 is made of metal wire, such as iron wire or steel wire. Additionally, the base 10 is a translucent plate or a transparent plate, which has a light transmittance over 30%, in such a way, the appearance of the transparent base 10 can is increased, and the ultraviolet light can pass through the base 10 to benefit the curing.

Further, the adhesive is a UV-curable adhesive. Specifically, the adhesive is liquid or gel before it is cured, and the adhesive is solid after it is cured. The adhesive includes oligomers 30%-75%, monomers 20%-70%, photoinitiators 1%-6% and additives 1.1%-13.8%. Furthermore, the additives include at least one selected from a group of thickener 0.5%-8%, leveling agent 0-0.5%, coupling agent 0.5%-5% and defoamer 0.1%-0.3%. The oligomers include at least one selected from a group of SARTOMER CN966J75NS (a product of Sartomer Company), Doublemer 353H (a product of Double Bond Chemical Ind., Co., Ltd.), EBECRYL 8413 (a product of Allnex Company). The monomers include at least one selected from a group of BOA, TMPTA, ACMO, THFA. The photoinitiators include at least one selected from a group of TPO and 184. The thickener is fumed silica, and the coupling agent is silicon coupling agent KH-550 or silicon coupling agent KH-570. The UV curable adhesive has good cohesion strength, good adhesion and high elongation, thus when the hook 100 is removed, the whole of the adhesive can be torn off.

The present invention further provides an assembly method of the adhesive hook 100, the method includes: providing a base 10 which has a bottom 11 for fixing, an outer surface 12, and a hook 20 formed on the outer surface 12; coating an adhesive 103 on the bottom 11 of the base 10; pasting the bottom 11 of the base 10 coated with the adhesive 103 on an external surface; and fixing the base 10 on the external surface by using a UV curable adhesive.

Furthermore, in the UV curing process for the adhesive, the power of the UV light is in a range of 1-6W, the curing time is 3-20 seconds, and the curing energy is 500-1000 mj/cm². Preferably, the wavelength of the UV radiation is 395 nm. For example, the UV radiation is supplied by an UV device such as a flashlight. Furthermore, the adhesive hook can made of plastic or glass, such as polystyrene, polyethylene, polypropylene, acrylonitrile-butadiene-styrene copolymer, polyethylene terephthalate or polycarbonate. Furthermore, the notch of the operation position 13 is trapezoidal or crescent-shaped. The inner top wall is inclined, and a flat-blade screwdriver can be inserted into the notch 13 along the inclined wall to pry the base 10.

UV curable adhesive is applied in this embodiment, UV radiation curing technology is called as “5E technology” because it's efficient, energy saving, environmental friendly, economic and enabling. Since the late 1960s, Bayer AG successfully developed light-cured wood coatings, UV curing technology has been rapid developed for more than 30 years, and has been widely used in coatings, inks and adhesives and other national economic fields.

As one of the most commonly used UV curing materials, the UV-cured adhesive has the “5E” advantage. Specifically, the use is convenient (applicable viscosity can be adjusted); the curing speed is fast, which is beneficial to achieve automatic production and improve work efficiency; the curing temperature is low, and the room temperature is suitable to save energy; and there is no solvent evaporation, with 100% curing. In addition, it has high transparency, reliability and waterproofness. Preferably, the present embodiment uses environment-friendly UV curable adhesive, which is applicable to the glass, PET, PP materials and has high strength and low viscosity.

The adhesive plays a critical role on the load bearing strength of the adhesive hook 100, and three embodiments of the adhesive follow.

### Embodiment 1

The adhesive includes:

| | |
|---|---|
| SARTOMER CN 966J75NS | 60%; |
| Doublemer 353H | 5%; |
| IBOA | 24%; |
| TMPTA | 5%; |
| Fumed silica | 2%; |
| TPO | 1.5%; |
| 184 | 0.5%; |
| Defoamer | 0.3%; |
| Silicon coupling agent KH-550 | 1.5%; |
| Leveling agent | 0.2%. |

### Embodiment 2

The adhesive includes:

| | |
|---|---|
| SARTOMER CN 966J75NS | 45%; |
| Doublemer 353H | 25%; |
| IBOA | 19%; |
| TMPTA | 3%; |
| Fumed silica | 1%; |
| TPO | 2%; |
| 184 | 0.5%; |
| Defoamer | 0.3%; |
| Silicon coupling agent KH-570 | 2%; |
| Leveling agent | 0.2%; |
| ACMO | 2%. |

### Embodiment 3

The adhesive includes:

| | |
|---|---|
| EBECRYL 8413 | 56.5%; |
| Doublemer 353H | 4%; |
| IBOA | 20%; |
| THFA | 7%; |
| TMPTA | 5%; |
| Fumed silica | 3%; |
| TPO | 1.5%; |
| 184 | 0.5%; |
| Defoamer | 0.3%; |
| Silicon coupling agent KH-550 | 2%; |
| Leveling agent | 0.2%. |

### Contrast Example

Conventional glass glue is used.

Specifically, the adhesives according to the three embodiments and the conventional glass glue are coated on the bottom of the adhesive hooks 100 respectively, and then the adhesive hooks are pasted on the glass. After the curing of the adhesives, a load bearing test is carried out. The test result shows that, the load bearing of the embodiments 1-3 reaches 1-1.5 KG/cm², and the adhesive hook can be removed from the glass easily, without remains. While the loading bearing of the contrast example namely is 0.3-0.5 KG/cm², and there is glass glue remains on the glass after the adhesive hook is removed.

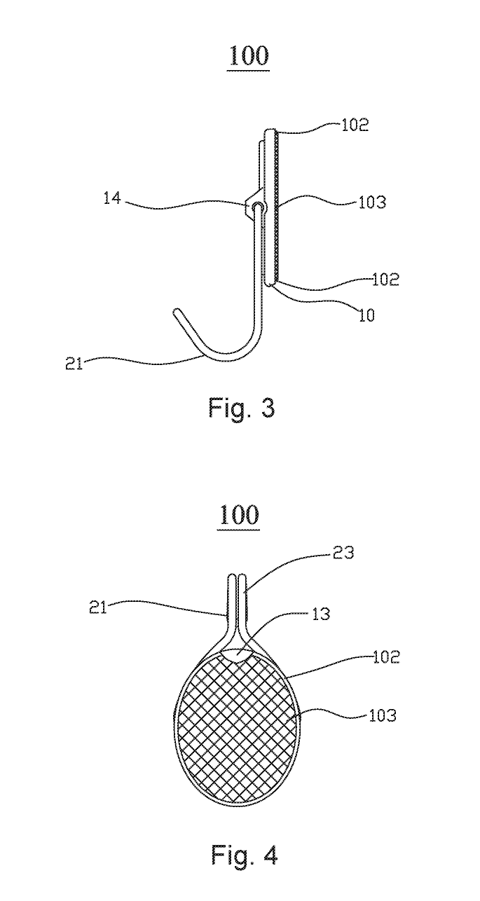

As shown in FIGS. 3 and 4, an adhesive layer 103 is evenly formed on the bottom 11, and a ring of flange 102 is formed around the base 10 to form a recess where the adhesive is coated to prevent the adhesive from overbriming the bottom 11. The adhesive layer 103 is surrounded by the flange 102, and the height of the flange 102 is slightly lower than the adhesive layer 103. Preferably, the height of the flange is 0.1-0.5 mm. Of course, the notch 13 can be provided with no flange portion 102.

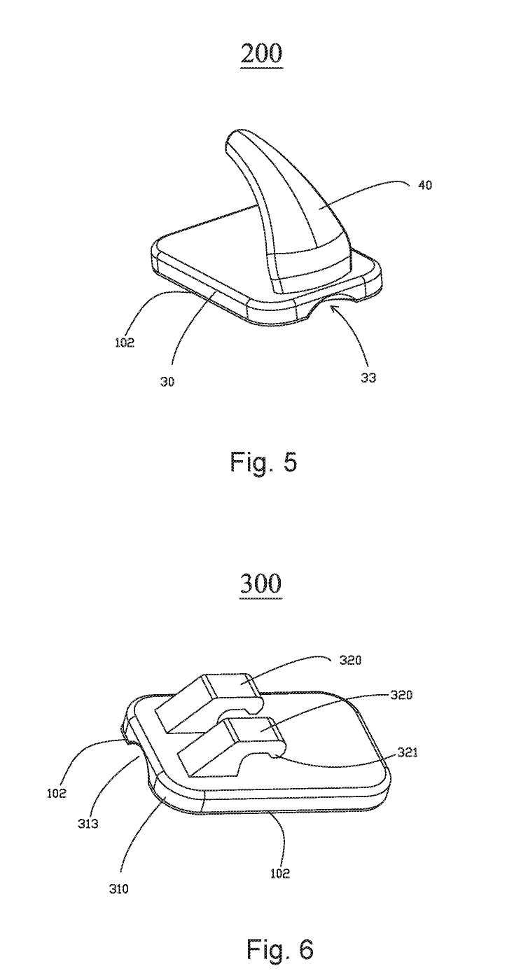

Referring to FIG. 5, an adhesive hook 200 according to a second embodiment includes a base 30 and a hook 40. The bottom of the base 30 is fixed on an external surface via adhesive. An operation portion 33 is provided at the edge of the bottom of the base, and the operation portion 33 is a notch formed by dipping the intersecting portion between the side of the base 10 and the bottom 11 of the base 10. Structure of the adhesive hook 200 shown in FIG. 5 is similar to that of FIGS. 1-4, the same numeral is directed to the same component and material; difference is that, the hook 40 and the base 30 in this embodiment are formed in integrated structure. Further, the hook 40 is in bent cone-shaped, and the operation portion 33 is an arc notch.

Referring to FIG. 6, an adhesive hook 300 according to a third embodiment includes a base 310 and a hook 320. The bottom of the base 310 is fixed on an external surface via adhesive. An operation portion 313 is provided at the edge of the bottom of the base, and the operation portion 33 is a notch formed by dipping the intersecting portion between the side of the base 10 and the bottom 11 of the base 10. Structure of the adhesive hook 300 shown in FIG. 6 is similar to that of FIG. 5, the same numeral is directed to the same component and material; difference is that, the amount of the hook 320 in this embodiment is two, and the hooks 320 are parallel and extended form the base 30, and a barb portion 321 is formed.

In comparison with the prior arts, since the base of the adhesive hook according to the present invention is coated with a curable adhesive, and then is pasted on an external surface by curing the adhesive. The structure of the adhesive hook is simple, and the curing speed of the curable adhesive is fast. After the curing process, the load bearing of the hook is larger than 1 Kg/cm². Further, the adhesive hook has high cohesion strength after the adhesive is cured, and no remain is pasted on the external surface or the base after the hook is removed. The base can be recoated with new adhesive to reuse, which reduces cost and achieves recycling.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. An adhesive hook, comprising a base which has a bottom for fixing, an outer surface, and a hook provided at the outer surface, wherein the bottom of the base is fixed on an external surface by means of an adhesive, and the adhesive is a curable adhesive.

2. The adhesive hook according to claim 1, wherein the external surface is a marble surface, a wood surface, a concrete wall surface, a tile surface or a glass surface.

3. The adhesive hook according to claim 1, wherein the adhesive is liquid or gel before it is cured, and the adhesive is solid after it is cured.

4. The adhesive hook according to claim 1, wherein the adhesive comprises below compositions: oligomers 30%-75%, monomers 20%-70%, photoinitiators 1%-6% and additives 1.1%-13.8%.

5. The adhesive hook according to claim 4, wherein the additives comprise at least one selected from a group of thickener 0.5%-8%, leveling agent 0-0.5%, coupling agent 0.5%-5% and defoamer 0.1%-0.3%.

6. The adhesive hook according to claim 4, wherein the oligomers comprise at least one selected from a group of SARTOMER CN966J75NS, Doublemer 353H, EBECRYL 8413, the monomers comprise at least one selected from a group of BOA, TMPTA, ACMO, THFA, and the photoinitiators comprise at least one selected from a group of TPO and 184.

7. The adhesive hook according to claim 5, wherein the thickener is fumed silica, and the coupling agent is silicon coupling agent KH-550 or silicon coupling agent KH-570.

8. The adhesive hook according to claim 1, wherein a bottom edge of the base is provided with an operation portion which is a notch formed by dipping an intersecting portion between a side of the base and the bottom of the base.

9. The adhesive hook according to claim 8, wherein the notch is trapezoidal or crescent-shaped, and the notch has an inclined inner top wall.

10. The adhesive hook according to claim 1, wherein the base is made of translucent or transparent material.

11. The adhesive hook according to claim 10, wherein the base and the hook are formed in an integrated structure by mean of injection molding, and made by translucent or transparent plastic with a light transmittance over 30%.

12. The adhesive hook according to claim 1, wherein the base and the hook are formed in individual structures, and the hook is pivotally connected to the base via an engaging structure, the hook is made of metal, a mounting ridge is protruded on the outer surface of the base, and the engaging structure is inserted into the mounting ridge.

13. The adhesive hook according to claim 1, wherein a ring of flange is formed around the base to form a recess where the adhesive is coated to prevent the adhesive from overbriming the bottom of the base.

14. The adhesive hook according to claim 1, wherein the base and/or hook are made of plastic or glass, and the plastic is at least one selected from a group of polystyrene, polyethylene, polypropylene, acrylonitrile-butadiene-styrene copolymer, polyethylene terephthalate and polycarbonate.

15. An assembly method of the adhesive hook according to claim 1, comprising:
providing a base, which has a bottom for fixing, an outer surface, and a hook provided at the outer surface;
pasting the bottom of the base on an external surface, with the bottom is coated with an adhesive that is a curable adhesive; and
curing the adhesive by means of ultraviolet light to fix the base on the external surface.

16. The assembly method according to claim 15, wherein power of the UV light is in a range of 1-6W, curing time is 3-20 seconds, and curing energy is 500-1000 mj/cm².
